(19) United States
(12) Patent Application Publication
(10) Pub. No.: US 2008/0114652 A1
(43) Pub. Date: May 15, 2008

(54) APPARATUS AND METHOD FOR PREDICTING THE PERFORMANCE OF A NEW INTERNET ADVERTISING EXPERIMENT

(75) Inventors: Leo Chang, San Carlos, CA (US); Michael Suzuki, San Mateo, CA (US); Jeyappragashi Jeyakeerth, Sunnyvale, CA (US)

Correspondence Address: MARGER JOHNSON & MCCOLLOM, P.C., 210 SW MORRISON STREET, SUITE 400, PORTLAND, OR, 97204, US

(73) Assignee: WEBTRENDS, INC., (US)

(21) Appl. No.: 11/867,631

(22) Filed: Oct. 4, 2007

Related U.S. Application Data
(60) Provisional application No. 60/828,366, filed on Oct. 5, 2006.

(51) Int. Cl. G06Q 30/00

(52) U.S. Cl. 705/14; 705/10

(57) ABSTRACT

A computer readable storage medium has executable instructions to identify a new Internet advertising experiment including values. The effectiveness of the values in prior Internet advertising experiments is evaluated. The performance of the new Internet advertising experiment is predicted based upon the effectiveness of the values in the prior Internet advertising experiments.

### CROSS-REFERENCES TO RELATED APPLICATIONS

This application claims the benefit from U.S. Provisional Patent Application No. 60/828,366 filed Oct. 5, 2006 whose contents are incorporated herein for all purposes.

### BACKGROUND OF THE INVENTION

1. Field of the Invention

This invention relates generally to digital data processing. More particularly, this invention relates to techniques for predicting the performance of new internet advertising experiments.

2. Description of the Prior Art

Internet advertising campaigns endeavor to enhance the return on investment associated with values (e.g., words) used in campaigns. It would be desirable to predict the performance of new internet advertising campaigns or experiments using data from previous internet advertising experiments.

### SUMMARY OF THE INVENTION

A computer readable storage medium has executable instructions to identify a new Internet advertising experiment including values. Te effectiveness of the values in prior Internet advertising experiments is evaluated. The performance of the new Internet advertising experiment is predicted based upon the effectiveness of the values in the prior Internet advertising experiments.

The apparatus for predicting the performance of a new Internet advertising experiment comprises a memory device operable with a performance predictor. The memory device is configured to store values of a prior Internet advertising experiment, the performance results of the prior Internet advertising experiment using those values, and new values of a new Internet advertising experiment. The performance predictor is operable to access the memory device to retrieve the values and performance results of the prior Internet advertising experiment, calculate the effectiveness of the values used in the prior Internet advertising experiment, and predict an effectiveness of the new Internet advertising experiment having new values shared with the prior Internet advertising experiment.

The method for launching a new Internet advertising experiment comprises identifying within a memory device values of the new advertising experiment for the plurality of factors. A program then evaluates the effectiveness of prior advertising experiments sharing at least one of the values identified for the new advertising experiment. The program predicts the performance of the new Internet advertising experiment based upon the effectiveness of the values in the prior Internet advertising experiments and launches the new advertising experiment responsive to the predicted performance.

### BRIEF DESCRIPTION OF THE DRAWINGS

The invention is more fully appreciated in connection with the following detailed description taken in conjunction with the accompanying drawings, in which:

FIG. 1 illustrates a computer configured in accordance with an embodiment of the invention.

FIG. 2 illustrates processing operations associated with an embodiment of the invention.

Like reference numerals refer to corresponding parts throughout the several views of the drawings.

### DETAILED DESCRIPTION

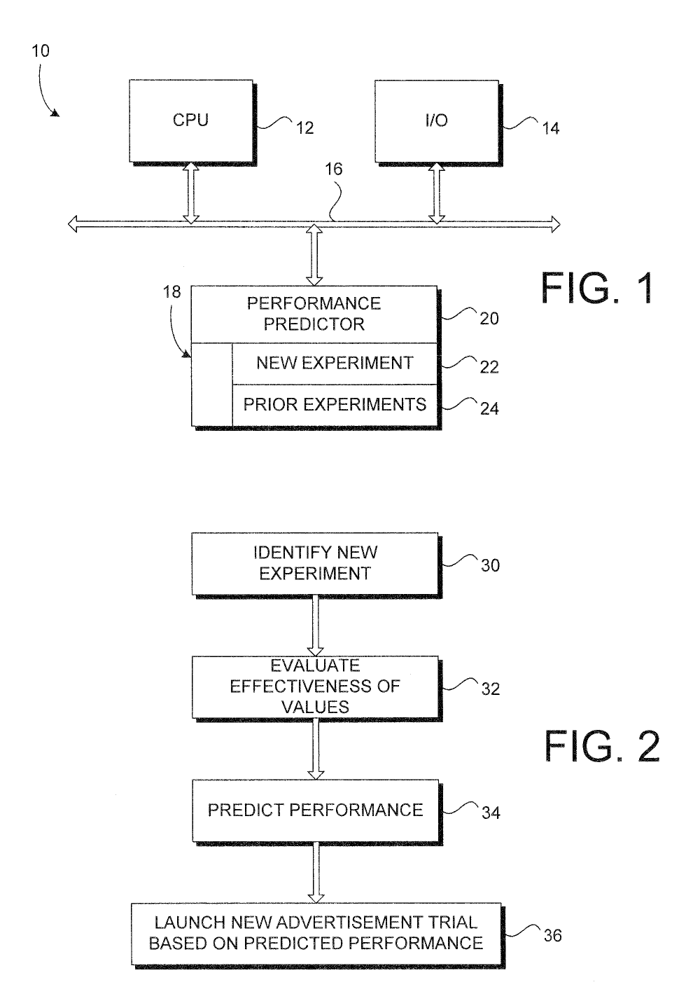

FIG. 1 illustrates a computer 10 configured in accordance with an embodiment of the invention. The computer 10 includes standard components, such as a central processing unit 12 and a set of input/output devices 14 connected via a bus 16. The input/output components may include a keyboard, mouse, display, printer, and the like. Also connected to the bus 16 is a memory 18.

The memory 18 stores executable instructions to implement operations of the invention. In particular, the memory 18 stores a performance predictor 20. The performance predictor 20 evaluates a new experiment 22 and prior experiments 24 to establish a prediction of the effectiveness of the new experiment using the techniques described below.

FIG. 2 illustrates processing operations associated with an embodiment of the invention. Initially, a new experiment is identified 30. Next, the effectiveness of values associated with the experiment are evaluated with respect to prior experiments 32. The performance of the new experiment is then predicted 34 with trials launched 36 based on this predicted performance as described further below.

In one embodiment of the invention, advertisements are organized into trials. Trials are parts of experiments. Experiments encompass a set of potential values, each of which belongs to factors. Trials are “realizations” of the combinations of potential values belonging to an experiment. Table 1 illustrates factors and potential values associated with an experiment. Table 2 illustrates trials, factors and values associated with an experiment.

TABLE 1
Advertisement Experiment #1

| FACTOR | POTENTIAL VALUES |
|---|---|
| Keyword | “camera” |
| | “photography” |
| | “digital camera” |
| Headline | “Great Discount Cameras” |
| | “Best Cameras on the Web” |
| Landing Page | www.mysite.com/cameras |
| | www.mysite.com/discounts |

TABLE 2
Trials from Advertisement Experiment #1

| TRIAL | FACTOR | POTENTIAL VALUES |
|---|---|---|
| Trial 1 | Keyword | “camera” |
| | Headline | “Great Discount Cameras” |
| | Landing Page | www.mysite.com/cameras |
| Trial 2 | Keyword | “photography” |
| | Headline | “Great Discount Cameras” |
| | Landing Page | www.mysite.com/discounts |
| Trial N | . . . | . . . |

Trials can be designed such that one trial is not required for every possible permutation of potential values in the experiment. This is a concept borrowed from conventional Design of Experiments (DOE) approaches.

With DOE approaches, the goal is to analyze the effectiveness of values within an experiment. Analyzing results across experiments is difficult. This is important because DOE has limits as to how many potential values can be reasonably handled within an experiment. With the present invention, many values across experiments are evaluated. This sharing of values across experiments means that an experiment that already has results can help predict performance for another experiment that has not yet started running.

To make use of this aspect of shared values, a new trial can make use of an existing trials' results—even trials that are from different clients or domains. Each value can be assigned several scores in the context of a campaign. The context of a Campaign is used because a Campaign has a business goal—typically with a ROAS target. (ROAS is Return on Ad Spend, which is equal to Revenue divided by Cost).

Based on the trials that a value has been a part of, each value can have aggregate metrics-not only for cost, clicks, revenue, and conversions, but also for important ratios such as ROAS (revenue/cost), average order value (AOV) (revenue/conversions), conversion rate (conversions/clicks), and cost per click (cost/clicks). There are various ways to aggregate trial metrics for any particular value. For example, if one wants to know an “average” ROAS for a particular value, one could either (1) take the sum of the revenue of all the trials it is a part of and divide it by the sum of the cost of all those trials (“Aggregate ROAS”) or (2) take the mean of all the ROAS values of all of those trials (“Trial-based ROAS Average”).

$$\begin{matrix}Aggregate ( R O A S ) = \frac{{\sum }_{i = 1}^{n} Revenue ( {t}_{i} )}{{\sum }_{i = 1}^{n} Cost ( {t}_{i} )} & ( 1 ) \\ Trial \text{-} based R O A S Average = \frac{{\sum }_{i = 1}^{n} ( \frac{Revenue ( {t}_{i} )}{Cost ( {t}_{i} )} )}{n} & ( 2 )\end{matrix}$$

In these equations, tᵢ refers to the past (or ongoing) trials that a particular value is a part of. A “new” trial—really any trial to be evaluated—has values that are a part of it. Specifically, one for each factor. Scores for each factor should be based on different metrics. Scores that evaluate a landing page, for instance, might depend heavily on the conversion rate and AOV, but not very much on cost—because a landing page cannot really influence cost in a pay-per-click scheme. Keywords, on the other hand, could be evaluated on ROAS, conversion rate, and AOV, but weighted differently across those three metrics. These weights are referred to as “influences”, as shown in Table 3. Note that these influences can be different for different clients.

TABLE 3
Influence Factors Weighting Effectiveness of Advertisement

| CLIENT | FACTOR | METRIC TYPE | INFLUENCE |
|---|---|---|---|
| Acme | Keyword | Aggregate ROAS | 3 |
| | | Trial ROAS Avg | 0 |
| | | Aggregate AOV | 0 |
| | | Trial AOV Avg | 1 |
| | | Aggregate Conv Rate | 2 |
| | | Trial Conv Rate Avg | 0 |
| | Landing Page | Aggregate ROAS | 0 |
| | | Trial ROAS Avg | 0 |
| | | Aggregate AOV | 0 |
| | | Trial AOV Avg | 3 |
| | | Aggregate Conv Rate | 2 |
| | | Trial Conv Rate Avg | 0 |
| | . . . | . . . | . . . |
| Megacorp | Keyword | Aggregate ROAS | 3 |
| | . . . | . . . | . . . |

There are also several ways to combine the scores for each value of the new trial in order to evaluate the trial as a whole. One way is to simply sum up the scores for all the values, then evaluate how “good” the summed score is. Another is to evaluate how “good” each value's score is individually, then combine the “goodness” of those evaluations—we call this the “voted score”. One embodiment of the invention uses the voted score to decide if a new trial is “good,” “bad,” or “neutral,” and the summed score is used as a measure of “volatility”—i.e., a measure of the variance of our prediction.

Another measure of variance can be calculated by tallying the number of trials involved in computing each value score: the more trials involved in each value score computation, the higher the confidence (and the lower the variance) in its predictive power.

Consider a new trial for the client Acme. It is “new” since it has no performance history of its own. Without the current invention, time and money must be spent on testing to get any data at all.

The trial has the keyword “discount stuff,” the advertising headline of “Wonderful Discount Junk,” and a landing page of “http://www.acme.com/discountjunk,” as show in the Table 4. Because Acme has had campaigns running in the past, there have been past trials (Old Trials 1 and 2) that have used “discount stuff” as keywords (though in combination with different values for other factors). Also, Old Trial 3 shares its landing page value with the new trial. The invention may use old trials from the same or different clients.

TABLE 4
New Trial Prediction Using Old Trials

| TRIAL | FACTOR | VALUE |
|---|---|---|
| New Trial | keyword | “discount stuff” |
| | headline | “Wonderful Discount Junk” |
| | landing page | http://www.acme.com/discountjunk |
| Old Trial 1 | keyword | “discount stuff” |
| | headline | — |
| | landing page | — |
| Old Trial 2 | keyword | “discount stuff” |
| | headline | — |
| | landing page | — |
| Old Trial 3 | keyword | — |
| | headline | — |
| | landing page | http://www.acme.com/discountjunk |

Unlike the new trial, these three old trials have results. Typically, none of the other trials in the same experiment with the new trial would have any results either, since trials from the same experiment are generated at the same time and would be ideally judged during the same time period. Sample results for the old trials are in the Table 5.

TABLE 5
Sample Old Trial Data

| TRIAL | REVENUE | COST | CONVERSIONS | CLICKS |
|---|---|---|---|---|
| Old Trial 1 | 100 | 20 | 4 | 80 |
| Old Trial 2 | 200 | 30 | 5 | 75 |
| Old Trial 3 | 35 | 30 | 1 | 50 |

If the influence values of Table 3 are used (reproduced in Table 6, below), calculating the value score for a keyword value for the Acme client involves the following metrics:

TABLE 6
Keyword Influence Values from Table 3

| METRIC TYPE | INFLUENCE |
|---|---|
| Aggregate ROAS | 3 |
| Trial ROAS Avg | 0 |
| Aggregate AOV | 0 |
| Trial AOV Avg | 1 |
| Aggregate Conv Rate | 2 |
| Trial Conv Rate Avg | 0 |

Assume that the influence numbers are used as linear weights in determining the value score. To determine the value score for the keyword “discount stuff,” one needs the Aggregate ROAS, the Trial AOV Avg, and the Aggregate Conversion Rate.

$$\begin{matrix}Agg R O A S = \frac{{\sum }_{i = 1}^{n} Revenue ( {t}_{i} )}{{\sum }_{i = 1}^{n} Cost ( {t}_{i} )} = \frac{100 + 200}{20 + 30} = 600 \% & ( 3 ) \\ \begin{matrix}Trial A O V Average = \frac{{\sum }_{i = 1}^{n} ( \frac{Revenue ( {t}_{i} )}{Conversion ( {t}_{i} )} )}{n} \\ = \frac{( \frac{100}{4} ) + ( \frac{200}{5} )}{2} \\ = 32.5\end{matrix} & ( 4 ) \\ Agg Conv Rate = \frac{{\sum }_{i = 1}^{n} Conversions ( {t}_{i} )}{{\sum }_{i = 1}^{n} Clicks ( {t}_{i} )} = \frac{4 + 5}{80 + 75} = 5.8 \% & ( 5 )\end{matrix}$$

Assume that this campaign for Acme is targeting a ROAS of 400%, that Acme's historical Average Order Value has been 35, and that its historical Conversion Rate has been 3.5%. Using these “neutral” numbers, one can evaluate if a particular ROAS, AOV, or Conv Rate figure is “good,” “bad”, or neither—(or perhaps “goodness” can be measured on a scale of 1 to 10, or a formula can be applied to give it a numerical value on a continuum.) One implementation of the invention uses +1 for good, −1 for bad, and 0 for neutral. In this case, 600% is good, 32.5 for AOV is neutral, and 5.8% Conv Rate is good.

Based on the influences values of Table 3, the value score for this keyword for Acme is:
ValueScore(“discountstuff”)=3*(+1)+1*(0)+2*(+1)=+5 (6)

As for the landing page of http://www.acme.com/discountjunk, the influence values from Table 3 are reproduced in Table 7 below:

TABLE 7
Landing Page Influence Values from Table 3

| METRIC TYPE | INFLUENCE |
|---|---|
| Aggregate ROAS | 0 |
| Trial ROAS Avg | 0 |
| Aggregate AOV | 0 |
| Trial AOV Avg | 3 |
| Aggregate Conv Rate | 2 |
| Trial Conv Rate Avg | 0 |

Since there is only one old trial involved, the calculations are simple.

$$\begin{matrix}Trial A O V Average = \frac{35}{1} = 35 & ( 7 ) \\ Agg Conv Rate = \frac{1}{50} = 2 \% & ( 8 )\end{matrix}$$

An AOV of 35 is neutral (same as historical AOV), and a conversion rate of 2% is bad (historical Conv Rate was 3.5%).
ValueScore(“http://www.acme.com/discountjunk”)=3*(0)+2*(−1)=−2 (9)
Now these scores can be combined to see the disposition for the new trial. Summing all the scores for each value yields +3 for the summed score. The voted score is zero (positive for keyword, negative for landing page, no vote for headline).

These scores can be used in several ways. For example, a set of very positive scores can be a signal for the system to launch this trial sooner, with a higher bid, and perhaps on more advertising networks. Negative scores can be a signal to lower the bid for this trial, to let other trials to launch first, or to not launch this trial at all.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

Having described and illustrated the principles of the invention in a preferred embodiment thereof, it should be apparent that the invention can be modified in arrangement and detail without departing from such principles. We claim all modifications and variation coming within the spirit and scope of the following claims.

What is claimed is:

1. A computer readable storage medium, comprising executable instructions to:
identify a new Internet advertising experiment including values;
evaluate the effectiveness of the values in prior Internet advertising experiments;
predict the performance of the new Internet advertising experiment based upon the effectiveness of the values in the prior Internet advertising experiments.

2. The computer readable storage medium of claim 1 further comprising executable instructions to establish a metric associated with a value.

3. The computer readable storage medium of claim 2 further comprising executable instructions to establish a metric selected from: aggregate Return on Ad Spend (ROAS), trial ROAS average, aggregate Average Order Value (AOV), trial AOV average, aggregate conversion rate, and trial conversion rate average.

4. The computer readable storage medium of claim 2 further comprising executable instructions to assign an influence value to a metric.

5. The computer readable storage medium of claim 4 further comprising executable instructions to establish strength factors.

6. The computer readable storage medium of claim 5 further comprising executable instructions to determine an effectiveness factor based upon influence values and strength factors.

7. The computer readable storage medium of claim 6 further comprising executable instructions to predict the performance based upon the effectiveness factor.

8. The computer readable storage medium of claim 1 further comprising executable instructions to report the performance.

9. An apparatus for predicting the performance of a new Internet advertising experiment, comprising:
a memory device storing values of a prior Internet advertising experiment, performance results of the prior Internet advertising experiment using those values, and new values of a new Internet advertising experiment;
a performance predictor operable to access the memory device to retrieve the values and performance results of the prior Internet advertising experiment, calculate the effectiveness of the values used in the prior Internet advertising experiment, and predict an effectiveness of the new Internet advertising experiment having new values shared with the prior Internet advertising experiment.

10. The apparatus of claim 9, wherein the memory device further includes stored thereon influence values for different metrics of the prior Internet advertising experiment, the performance predictor further including a calculator configured to apply linear weights using the influence values stored in memory to predict the effectiveness of the new Internet advertising experiment.

11. The apparatus of claim 10, wherein the metrics are selected from: aggregate Return on Ad Spend (ROAS), trial ROAS average, aggregate Average Order Value (AOV), trial AOV average, aggregate conversion rate, and trial conversion rate average.

12. The apparatus of claim 9, further including a new Internet advertisement experiment launcher configured to launch a trial of the new Internet advertisement experiment responsive to results from the performance predictor.

13. A method for launching a new Internet advertising experiment comprising a plurality of factors comprising at least one of keywords, headers, or landing pages, the method comprising:
identifying within a memory device values of the new advertising experiment for the plurality of factors;
evaluating the effectiveness of prior advertising experiments sharing at least one of the values identified for the new advertising experiment;
predicting the performance of the new Internet advertising experiment based upon the effectiveness of the values in the prior Internet advertising experiments; and
launching the new advertising experiment responsive to the predicted performance.

14. The method of claim 13, wherein the step of predicting the performance of the new Internet advertising experiment further includes calculating a value score for each value of the new Internet advertising experiment.

15. The method of claim 14, wherein the step of launching the new advertising experiment includes:
summing the value score for each value of the new Internet advertising experiment; and
launching the new advertising experiment if the summed value score meets a certain threshold.

16. The method of claim 14, wherein the step of launching the new advertising experiment includes:
summing the value score for each value of the new Internet advertising experiment; and
launching the new advertising experiment sooner, with a higher bid, or on more advertising networks if the summed value score meets a certain threshold.

17. The method of claim 14, wherein the step of launching the new advertising experiment includes:
summing the value score for each value of the new Internet advertising experiment; and
if the summed value score is below a certain threshold, not launching the new Internet advertising experiment, lowering the bid, or delaying a launch of the new advertising experiment.

18. The method of claim 14, further including:
establishing metrics associated with each value;
assigning weighting factors to each of the metrics based on the factor to which the values are associated;
calculating the value score for each value of the new Internet advertising experiment incorporating these weighting factors; and
calculating a voted score from these value scores and associating the predicted performance of the new advertising experiment with the voted score.
